(19) United States
(12) Patent Application Publication
(10) Pub. No.: US 2015/0165971 A1
(43) Pub. Date: Jun. 18, 2015

(54) REAR SPACE MONITORING SYSTEM AND METHOD FOR MONITORING THE REAR SPACE OF A VEHICLE

(71) Applicant: Robert Bosch GmbH, Stuttgart (DE)

(72) Inventor: Thilo GRUNDMANN, Hildesheim (DE)

(21) Appl. No.: 14/567,803

(22) Filed: Dec. 11, 2014

(30) Foreign Application Priority Data
Dec. 12, 2013 (DE) 10 2013 225 773.2

(51) Int. Cl. B60Q 9/00; H04N 7/18; B60R 1/00

(52) U.S. Cl. CPC B60Q 9/008; B60R 1/00; H04N 7/183

(57) ABSTRACT

A rear space monitoring system for vehicles is provided, in particular vehicles having no body, including at least one image recording sensor which records images of surroundings behind a driver, a control unit which evaluates the recorded images, detects an object as a function of the evaluated images when a drop below a certain distance from the vehicle occurs and generates a signal. The signal activates at least one actuator which warns the driver about the detected object, the at least one actuator being situated close to the skin of the driver.

### FIELD OF THE INVENTION

The present invention is directed to a rear space monitoring system and to a method for monitoring the rear space.

### BACKGROUND INFORMATION

A motorcycle rear view system is described in German Patent No. 20 2005 013 661 U1, which includes an image detection system which is positioned in a rear end area of the motorcycle and includes a display system situated in the visual range of the driver. The connection between the image detection system and the display system is hard-wired. Image data are transmitted via this connection from the image detection system to the display system and are displayed as an image on the display system.

### SUMMARY

It is an object of the present invention to draw the driver's attention to a vehicle in the rear surroundings.

A rear space monitoring system for vehicles, in particular vehicles having no body, such as a motorcycle, a trike, an ATV, or an electric two-wheeled vehicle, includes at least one image recording sensor which records images of surroundings behind a driver. The rear space monitoring system includes a control unit, which evaluates the recorded images and detects an object as a function of the evaluated images when the object drops below a certain distance from the vehicle. The certain distance shall be regarded as a kind of threshold value. The certain distance includes a radius of up to 10 m around the vehicle, for example. The control unit generates a signal when the object drops below the certain distance. According to the present invention, the signal activates at least one actuator which warns the driver about the detected object. The at least one actuator is situated close to the skin of the driver, for example in the fingertips of a glove or on the overall of a motorcycle driver outfit. Close to the body here shall be understood to mean that the actuator may have skin contact or be at a small distance from the skin surface of the driver.

The advantage here is that the driver is warned about objects in the immediate surroundings which are not visible to him by utilizing the tactile sense of the driver. The warning thus occurs intuitively for the driver, and the driver is not distracted from the further traffic events, for example by turning the head.

In one refinement, the control unit continuously detects the distance between the detected object and the vehicle when the detected object approaches the vehicle. The control unit activates further actuators as a function of the distance between the detected object and the vehicle. The further actuators may be situated in an array, for example in a circular shape; however, they may also be individually situated in various locations of the skin surface of the driver, for example the left and/or right upper arm(s) and/or left and/or right shoulder(s), or the like.

It is advantageous here that the driver is able to directly assess the distance between the object and the vehicle as a result of the activation of multiple actuators.

In one further embodiment, the at least one actuator is a pressure actuator.

The advantage here is that the information content of the warning is more quickly detectable for the driver due to the pressure distribution on the skin as a result of the activation of various actuators.

In one refinement, the control unit detects a potential collision between the object and the driver. The control unit activates further actuators which are situated around the already activated actuators, for example, or are situated at a clear distance from the already activated actuators on the skin of the driver. In this way, a planar activation of the actuators results in the first case, and a punctiformly distributed activation of the actuators results in the second case. It is also possible to increase the pressure on the already activated actuators when the object is on a collision course with the vehicle.

In one further embodiment, a display system is situated in the visual range of the driver. The display system displays the detected object as a function of the distance from the vehicle. The detected object is highlighted by appearing in color or by flashing, for example.

The advantage here is that the information content of the warning allows the driver to detect and assess the impending danger more quickly as a result of a combined warning, which includes both the tactile sense and the visual sense of the driver.

In one refinement, the rear space monitoring system includes an inertial sensor system which detects a rotational movement of the image recording sensor, in particular a roll angle or an inclination of the vehicle. The control unit evaluates the images as a function of the rotational movement and displays the detected object on the display system in a highlighted fashion as a function of the distance from the vehicle.

In one further embodiment, the rear space monitoring system includes odometry sensors which detect a steering movement of the vehicle, in particular a yaw angle. The control unit evaluates the images as a function of the steering movement and displays the detected object on the display system in a highlighted fashion as a function of the distance from the vehicle.

It is advantageous here that the images are displayed on the display system without distortion.

In one refinement, the signal additionally activates a loudspeaker which outputs a warning in the form of an acoustic signal.

In one further embodiment, the warning includes the generation of driving noise of a vehicle including an internal combustion engine or driving noise of an electric vehicle.

The advantage here is that the driver is able to recognize what type of vehicle the object is, i.e., he/she is able to estimate the speed of the object and thus better assess the danger.

A method for rear space monitoring includes the detection of surroundings behind a driver with the aid of an image recording sensor and the evaluation of the recorded images in a control unit. The method furthermore includes the detection of an object as a function of the evaluated images, the object dropping below a certain distance from the vehicle, and a signal being generated as a function of the detected object. According to the present invention, at least one actuator, which is situated on the skin of the driver, is activated with the aid of the signal, in particular a pressure actuator. The at least one actuator thus warns the driver about the detected object.

In one refinement, a distance between the detected object and the vehicle is continuously detected when the detected object approaches the vehicle. Further actuators are activated as a function of the distance.

In one further embodiment, a potential collision between the object and the vehicle is recognized, and further actuators are activated or the pressure on the already activated further actuators is increased.

### BRIEF DESCRIPTION OF THE DRAWINGS

FIG. 1 shows a rear space monitoring system according to the present invention for a vehicle, in particular having no body.

FIG. 2 shows a method according to the present invention for monitoring the rear space of a vehicle having no body.

### DETAILED DESCRIPTION

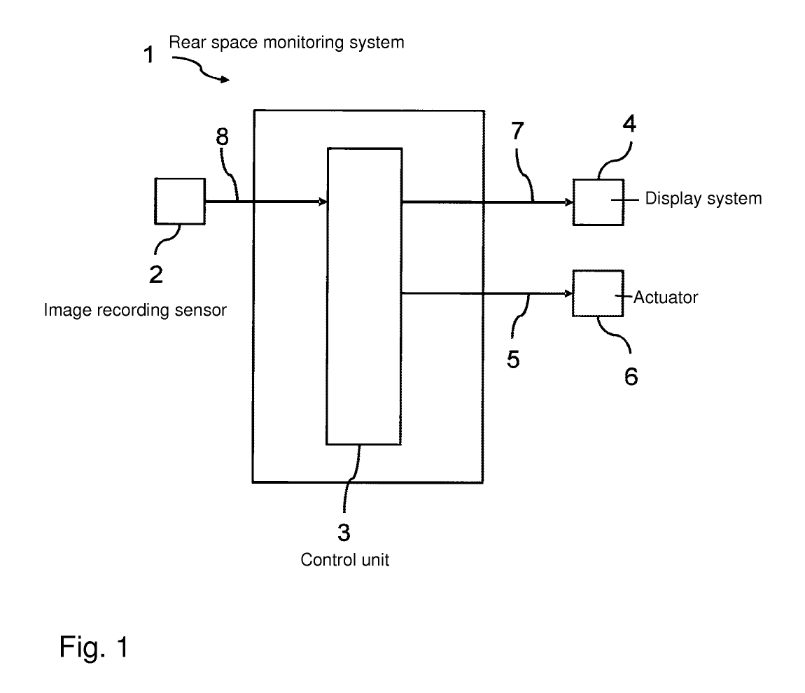

FIG. 1 shows rear space monitoring system 1 for vehicles having no body. This includes vehicles of the European vehicle class L, such as motorcycles, mopeds, trikes and ATVs. The vehicles having no body also include bicycles and electric two-wheeled vehicles, such as e-bikes and pedelecs. Rear space monitoring system 1 includes at least one image recording sensor 2, a control unit 3 and an actuator 6. Control unit 3 may be connected to image recording sensor 2 and actuator 6 both by being hard-wired 5, 8 and wirelessly. Image recording sensor 2 is situated on the bodiless vehicle in such a way that it is able to detect the rear space, i.e., the surroundings behind the driver. Image recording sensor 2 may be a camera having a fisheye lens which is directed against the driving direction. Image recording sensor 2 may also include multiple cameras having standard lenses, which are preferably situated behind the driver around the bodiless vehicle and cover the rear surroundings. Moreover, wide angle lenses or 360° lenses may be used. Image recording sensor 2 may be attached to the luggage rack, e.g., above the license plate, or to the saddle. In the case of a 360° lens, the image recording sensor should be situated at a very high point of the vehicle. A camera on the helmet of the driver, which allows an all-round view, would also be conceivable. Actuator 6 is designed as a pressure actuator, for example, and is situated close to the skin of the driver. In the case of a motorcycle driver, actuators 6 may be situated in the fingertips of the gloves, whereby the pressure actuators may have direct skin contact.

Furthermore they may be situated in the overall or as wearable electronics in the motorcycle driver outfit. Actuators 6 are attached in or on the clothing in such a way that they may either have direct skin contact or are at a distance from the skin of at least the fabric thickness of the clothing. For bicycle or electric two-wheeled vehicle drivers, who normally do not wear gloves, the actuators may also be situated on the grips of the handlebar so that the palms of the driver have contact with actuators 6. Actuators 6 may be provided individually, distributed in certain points, or in the form of an actuator array close to the skin of the driver. Control unit 3 is optionally hard-wired 5 or wirelessly connected to a display system 4. Display system 4 may be a display which is fixedly installed on the vehicle, for example on the handlebar. Alternatively, it may be a detachable display. A smart phone would also be suitable as a display, the mounting for the smart phone being attachable to the handlebar or the top tube of the vehicle. Goggles are also suitable as display system 4, similar to Google Glass goggles, which project visual information into the visual field of the driver. For a motorcycle driver, overlaying on the visor of the full face helmet would be conceivable. The preferred illustration on the display is the bird's eye view.

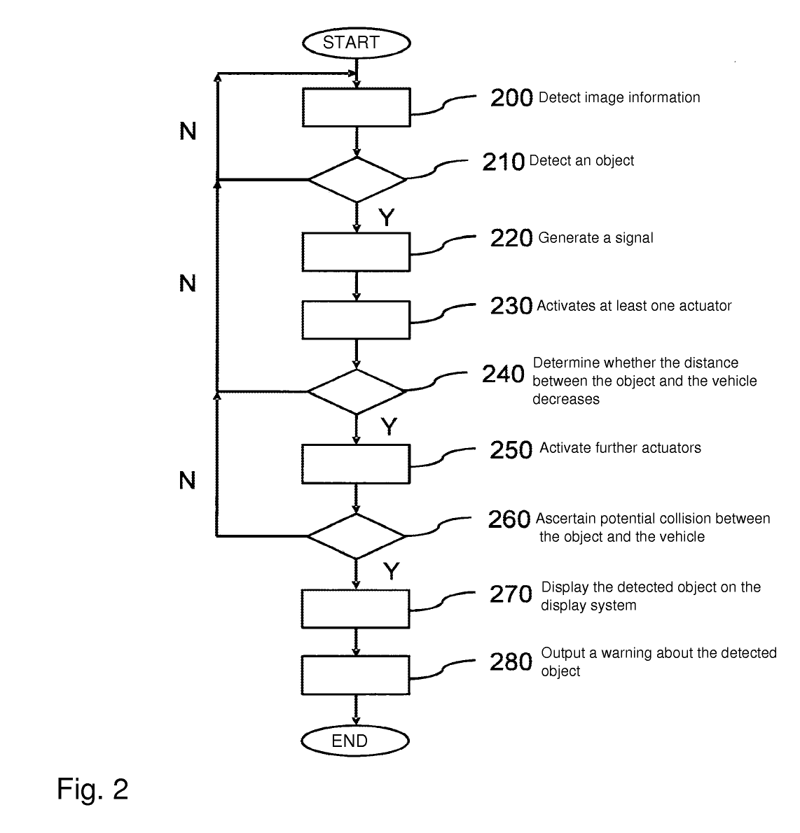

FIG. 2 shows a method for monitoring the rear space for vehicles having no body, i.e., bodiless vehicles. The method is started with step 200 by detecting image information with the aid of the image recording sensor and evaluating at least two detected pieces of image information with the aid of known image processing techniques, such as optical flow or classification methods. In a subsequent step 210, an object is detected when it drops below a certain distance from the vehicle. This certain distance shall be regarded as a kind of threshold value. For example, the value for the certain distance is fixedly predefined by a radius around the vehicle, e.g., 5 m, 10 m or 15 m, or dependent on the speed. The faster the vehicle, the larger the certain distance must be selected, since at higher speeds the response time of the driver for processing the warning and carrying out a driving maneuver, if necessary, should be sufficiently long to prevent a collision. If no object is detected in step 210, the method starts again with step 200. In a step 220 following step 210, a signal is generated, which in a subsequent step 230 activates at least one actuator which warns the driver about the detected object. The warning is generated in the form of a pressure on the skin surface of the driver, either by a single actuator in a particular location, for example on the left shoulder, by multiple actuators which are distributed on the skin surface of the driver at a larger distance, or by an actuator array which is applied in a planar fashion but locally. In a step 240, which follows step 230, it is optionally detected whether the object detected in step 210 approaches the vehicle, i.e., whether the distance between the object and the vehicle decreases. If this is the case, the distance between the object and the vehicle is continuously detected, and further actuators are activated as a function of the distance in a subsequent step 250. In this way, for example, a punctiform pressure warning may be carried out by various individually distributed actuators. For example, a first actuator is activated when a drop below the threshold value occurs, and upon further approaching, the further actuators are continuously activated either at a certain time interval or as a function of the distance of the detected object from the vehicle. A further warning option is the activation of multiple actuators situated in one location. The pressure warning is thus carried out in a planar fashion on the skin surface of the driver. Alternatively, the pressure applied to the skin surface by one actuator may be continuously increased. If a potential collision between the object and the vehicle is ascertained in an optional step 260, which follows step 250, the pressure which the at least one actuator exerts on the skin surface may be increased. As an alternative, further actuators may be connected. In an optional step 270, which follows step 260, the detected object is displayed on a display system 4 as a function of the distance from the vehicle and is highlighted by overlaying additional information, i.e., augmented reality, for example in color or by flashing. In a subsequent step 280, a warning about the detected object may optionally be output in the form of an acoustic signal via loudspeakers. The warning may also simulate driving noise of a vehicle including an internal combustion engine or driving noise of an electric vehicle. As an alternative, the ambient noise may be recorded and assigned to the detected object after the detected object has been classified, so that realistic noise may be used as the warning.

In one exemplary embodiment, a motorcycle is configured with at least three cameras, which together have a detection range of 180°. One camera is situated on the left side, one on the right side behind the driver, and one at the same height as the two others above the license plate. With the aid of known stitching algorithms, a 180° view is generated from the image information of the three cameras. With the aid of known classification methods, objects which drop below a threshold value from the motorcycle are recognized. The threshold value is adjusted as a function of the speed of the motorcycle. In a first case, a vehicle passes the motorcycle. The vehicle exceeds the threshold value, i.e., a drop below the certain distance between the vehicle and the motorcycle occurs. The driver's attention is drawn to the passing vehicle with the aid of a first pressure actuator, which is situated in the overall of his/her motorcycle outfit, so that he/she does not change lanes. If the distance between the vehicle and the motorcycle decreases further, either the pressure which the first pressure actuator exerts on the skin of the driver may be increased, or further actuators may be additionally activated. The further actuators may be situated in a circular shape around the first pressure actuator. The pressure which is exerted by the additional actuators on the skin may be higher than the pressure on the first pressure sensor. However, the further actuators may also be individually distributed on the skin surface. In a second case, the rear space monitoring system detects a vehicle which is on a collision course with the motorcycle. The driver is warned about this vehicle in two stages. The first warning takes place with the aid of a pressure actuator when the vehicle drops below the certain distance from the motorcycle. If the distance between the motorcycle and the vehicle decreases further, a second warning is generated with the aid of the further actuators. A planar pressure is exerted on the skin surface of the motorcycle driver for this purpose. The closer the vehicle approaches the motorcycle, the stronger becomes the pressure which the pressure actuators exert on the skin. If the vehicle leaves the collision course, the pressure on the skin is lifted.

What is claimed is:

1. A rear space monitoring system for a vehicle, comprising:
at least one image recording sensor that records an image of surroundings behind a driver; and
a control unit that evaluates the recorded image, detects an object as a function of the evaluated image when a drop below a certain distance from the vehicle occurs, and generates a signal, wherein the signal activates at least one actuator that warns the driver about the detected object, the at least one actuator being situated close to a skin of the driver.

2. The rear space monitoring system as recited in claim 1, wherein the vehicle is a vehicle having no body.

3. The rear space monitoring system as recited in claim 1, wherein the control unit continuously detects a distance between the detected object and the vehicle when the distance within the certain distance decreases, and activates further actuators as a function of the distance, which are situated on the skin of the driver.

4. The rear space monitoring system as recited in claim 1, wherein the at least one actuator is a pressure actuator.

5. The rear space monitoring system as recited in claim 4, wherein the control unit recognizes a potential collision between the object and the vehicle and one of activates further actuators and increases the pressure which is applied to the further actuators, when the object is on a collision course with the vehicle.

6. The rear space monitoring system as recited in claim 1, further comprising:
a display system situated in a visual range of the driver, wherein the display system displays the detected object in a highlighted fashion as a function of a distance from the vehicle.

7. The rear space monitoring system as recited in claim 6, further comprising:
an inertial sensor system which detects a rotational movement of the image recording sensor, wherein the control unit evaluates the image as a function of the rotational movement and displays the object on the display system in a highlighted fashion as a function of a distance from the vehicle.

8. The rear space monitoring system as recited in claim 7, wherein the inertial sensor system detects a roll angle of the vehicle.

9. The rear space monitoring system as recited in claim 6, further comprising:
an odometry sensor which detects a steering movement, wherein the control unit evaluates the image as a function of the steering movement and displays the object in a highlighted fashion as a function of a distance from the vehicle.

10. The rear space monitoring system as recited in claim 9, wherein the steering movement includes a yaw angle.

11. The rear space monitoring system as recited in claim 1, wherein the signal additionally activates a loudspeaker which outputs a warning in the form of an acoustic signal.

12. The rear space monitoring system as recited in claim 11, wherein the control unit generates one of a driving noise of a vehicle of an internal combustion engine and a driving noise of an electric vehicle as the warning.

13. A method for monitoring the rear space of a vehicle, comprising:
detecting surroundings behind a driver with the aid of an image recording sensor that produces a recorded image of the surroundings;
evaluating the recorded image in a control unit;
detecting an object as a function of the evaluated image to determine whether the object drops below a certain distance from the vehicle;
generating a signal as a function of the detected object; and
activating at least one actuator with the aid of the signal, the at least one actuator warning the driver about the detected object, the actuator being situated on a skin of the driver.

14. The method as recited in claim 10, wherein the vehicle is a vehicle having no body.

15. The method as recited in claim 13, wherein the actuator includes at least one pressure actuator.

16. The method as recited in claim 13, wherein a distance between the detected object and the vehicle is continuously detected when the distance within the certain distance decreases, and further actuators are activated as a function of the distance from the vehicle.

17. The method as recited in claim 16, wherein a potential collision between the object and the vehicle is recognized, and one of the further actuators are activated and a pressure on the further actuators is increased.
